(19) United States
(12) Patent Application Publication
(10) Pub. No.: US 2016/0231167 A1
(43) Pub. Date: Aug. 11, 2016

(54) Integrated Data Capture Station For Fish, Animals, Or Other Objects

(71) Applicant: Barbara P. Masin, Santa Barbara, CA (US)

(72) Inventor: Barbara P. Masin, Santa Barbara, CA (US)

(21) Appl. No.: 14/619,448

(22) Filed: Feb. 11, 2015

(51) Int. Cl. G01G 23/44; G06K 7/10

(52) U.S. Cl. CPC G01G 23/44; G06K 7/10415; G06K 7/10386

(57) ABSTRACT

Methods and systems are disclosed for automated data capture for fish, other animals, or other objects. In certain embodiments, an object is placed on an integrated platform that includes a scale, a length measurement board, a controller, a data storage system, and a display along with radio frequency identification (RFID) tags each having a unique identifier. The unique identifiers are associated with data values through one or more configuration files stored within the system. During data capture sessions, the integrated RFID tags are selectively read using an RFID reader, and one or more data values are automatically identified based upon each of the read unique identifiers and the configuration file loaded for the capture session. Data values for the object are then automatically stored within a data storage system. The integrated data capture station embodiments can be water resistant to facilitate data capture in wet or humid environments.

### TECHNICAL FIELD OF THE INVENTION

The present invention relates generally to data collection for objects, such as fish, and more particularly to such data collection in wet or humid environments.

### BACKGROUND

Electronic identification tags, including LF-RFID (low frequency radio frequency identification) tags and UHF-RFID (ultra-high frequency radio frequency identification) tags, have been used for assets management, container safety inspection purposes, fraud prevention, ownership identification, and/or other purposes. For asset tracking, RFID tags typically include programmable or read-only memories that are programmed with identification information or unique identifiers, and the RFID tags are adhered or otherwise affixed to the item to be tracked. The RFID tags are later read by an electronic RFID reader to obtain the stored identification information or unique identifiers. RFID tags are often implemented as an assembly incorporating an RFID transponder within a protective housing.

One application for RFID tags is to track and/or identify animals. For example, RFID tags can be imbedding underneath the skin or otherwise inserted into or affixed to an animal. A unique identifier can be stored within the RFID tag, and this unique identifier can be associated with the animal within a central database. The RFID tag can later be read using an RFID reader to obtain the unique identifier and identify the animal using the unique identifier.

In addition to identifying animals, it is also often desirable to capture or collect data about the animal. For example, fisheries, commercial aquaculture operations, commercial poultry operators and/or governmental agencies often desire to track data associated with fish or other animals over time. Example data that is often tracked includes growth data (weight and length) that are captured over time to determine how animals grow over time. Other data associated with the animals can also be collected such as disease, color, sex (male/female), and/or other information. This captured data can be stored for later use and analysis. Once an animal is tagged with RFID tag, that animal can later be identified using the RFID tag so that data collected for the animal can be compared to earlier data collected for that same animal. RFID tags can similarly be used with respect to other animals to capture and compare data over time. In addition to animals, the same techniques can also be used with respect to other objects for which data is desired to be captured.

Data capture stations currently used to capture data for animals, such as fish, have discrete and physically separate components that are exposed to the environment. These components include, for example, an electronic scale, a keyboard, a computer system, and a separate length measurement board, which can be pressure sensitive and used with or without a touch pen. An additional discrete RFID reader is also sometimes provided with special software designed to capture the animal's unique identifier from the RFID tag. Such prior capture stations also allow manual keypad data entry of weight values, length values, and/or other data values associated with the animal.

These prior capture stations, however, are not very efficient because discrete components are cobbled together and at least some of these may be subject to environmental contamination that can cause problems with the discrete components used for the capture station. For example, water or high humidity environments can cause significant problems with current keypad data entry during the collection of data for fish and/or during collection of data for other animals or objects in water or high humidity environments. Other environmental contaminations can also occur. Further, the manual keypad data entry for these prior capture stations represents a significant opportunity for data entry errors.

### SUMMARY OF THE INVENTION

Methods and systems are disclosed for automated data capture for fish, other animals, or other objects. In certain embodiments, an object is placed on an integrated platform that includes a scale, a length measurement board, a controller, a data storage system, and a display along with a series of different integrated frequency identification (RFID) tags. A weight for the object is automatically measured with the scale that is integrated with the platform to generate a weight value. One or more of the RFID tags that are also integrated with the platform are selectively read, for example, using an RFID reader that that can be selectively positioned to independently read each of the RFID tags. Each RFID tag stores a unique identifier that can be read by the RFID reader, and each of the unique identifiers is associated with one or more data values through one or more configuration files stored within the system. When a unique identifier is read, one or more data values for the object are then automatically identified based upon each of the unique identifiers that are selectively read depending upon which of the one or more configuration files has been loaded for that capture session. The weight value and the data values for the object are then automatically stored within a data storage system. An RFID identifier for the object itself can also be automatically read and stored within the data storage system as part of the object related data being captured and stored for the object. A plurality of objects, such as fish, other animals, or other objects can be processed using the integrated data capture station embodiments described herein. Further, the integrated platform and the integrated RFID tags can be configured to be water resistant to facilitate data capture in wet or humid environments. Other features and variations can be implemented, if desired, and related systems and methods can be utilized as well.

In one embodiment, a method for automated object data capture is disclosed that includes placing an object on a platform, automatically measuring a weight for the object with a scale integrated with the platform to generate a weight value, selectively reading one or more radio frequency identification (RFID) tags integrated with the platform with each RFID tag having a unique identifier stored within the RFID tag, automatically identifying one or more data values for the object based upon each of the unique identifiers, and automatically storing the weight value and the one or more data values for the object within a data storage system, and repeating the placing, automatically measuring, selectively reading, automatically identifying, and automatically storing for a plurality of objects.

For additional embodiments, the RFID tags are sealed within the platform and the platform is water resistant. For further embodiments, the method includes automatically reading an object identifier from an RFID tag associated with the object and including the object identifier within the data values stored for the object in the data storage system. For still further embodiments, the placing for the method includes placing the object on a length measurement board integrated with the platform, and wherein the scale is integrated with the length measurement board. In addition, the method can also include automatically reading an object identifier associated with the object using an RFID reader integrated with the length measurement board.

For further embodiments, the method includes associating one or more data values with each unique identifier using a configuration file stored in the data storage system. For additional embodiments, the one or more data values for a plurality of unique identifiers include different length values. Still further, the method can also include selecting one of a plurality of configuration files for the associating.

For still further embodiments, the selectively reading for the method is performed by separately positioning an RFID reader to read each one the one or more RFID tags. In additional embodiments, the plurality of objects include fish.

In another embodiment, a system for automated object data capture is disclosed that includes a platform, a scale integrated with the platform and configured to automatically measure a weight for an object placed on the scale to generate a weight value, a plurality of radio frequency identification (RFID) tags integrated with the platform with each RFID tag having a unique identifier stored within the RFID tag, an RFID reader configured to read the unique identifiers from the RFID tags, a data storage system, one or more configuration files stored within the data storage system with each configuration file associating one or more data values with each of the unique identifiers for the RFID tags, and a controller configured to automatically receive the weight value and the unique identifiers read by the RFID reader, to automatically identify one or more object data values associated with each of the unique identifiers read by the RFID reader using the one or more configuration files, and to automatically store within the data storage system the weight value and the one or more object data values for the object.

For additional embodiments, the system also includes a display integrated with the platform and configured to display the weight value. For further embodiments, the RFID tags are sealed within the platform and the platform is water resistant. For still further embodiments, the system also includes an RFID reader integrated with the platform and configured to automatically read an object identifier from an RFID tag associated with the object, and the controller is further configured to store the object identifier within the data values stored for the object in the data storage system. For additional embodiments, the system also includes a length measurement board integrated with the platform, and the scale is integrated with the length measurement board. In addition, the system can also include an RFID reader integrated with the length measurement board and configured to automatically read an object identifier from an RFID tag associated with the object.

For further embodiments, the one or more data values for a plurality of unique identifiers comprise different length values. For additional embodiments, a plurality of configuration files are stored in the data storage system, and the controller is further configured to allow user selection to determine which configuration file is used to automatically identify one or more object data values associated with each of the unique identifiers read by the RFID reader.

For still further embodiments, the system can also include an RFID reader configured to be selectively positioned with respect to the RFID tags and to read unique identifiers from the RFID tags. In additional embodiments, the plurality of objects include fish.

Different and/or additional features, variations, and embodiments can also be implemented, as desired, and related systems and methods can be utilized, as well.

### DESCRIPTION OF THE DRAWINGS

It is noted that the appended drawings illustrate only exemplary embodiments of the invention and are, therefore, not to be considered limiting of its scope, for the invention may admit to other equally effective embodiments.

FIG. 1 is a perspective diagram of an example embodiment for an integrated data capture system.

FIG. 2 is a block diagram of an example embodiment for components of the integrated capture station depicted in FIG. 1.

FIG. 3 is a process flow diagram of an example embodiment for automated data capture for fish, other animals or other objects.

### DETAILED DESCRIPTION OF THE INVENTION

Methods and systems are disclosed for automated data capture for fish, other animals, or other objects. The integrated data capture embodiments described herein allow operators to automatically identify an object, such as an animal, that is being weighed and to automatically capture other data about the object, such as weight and length data as well as other desired data. In contrast with prior solutions, the disclosed embodiments include a scale, a measuring board, and an object reader that are physically integrated within the data capture station along with radio frequency identification (RFID) tags that allow for automated data entry for a wide variety of data. In particular, a series of RFID tags are integrated with the platform for the data capture station embodiments, and one or more object data values are assigned to each RFID tag through one or more configuration files that are selected depending upon the data capture desired for a particular data capture session. For example, a first set of data values can be assigned to the RFID tags for data capture on a first day of data capture operations, and a second set of object-related data values can be assigned to the RFID tags on a second day of data capture operations. By using the RFID tags and selectively assigning data values to the unique identifiers stored within the RFID tags, a wide variety of data can be automatically collected and stored for objects by selectively reading individual RFID tags during a capture sessions. As such, the disclosed embodiments eliminate any requirement for manual keypad data entry thereby improving data accuracy for the collected data. Further, the integrated data capture system can more easily be made to be water resistant thereby improving reliability in wet and humid environments or in other difficult collection environments. Additional communication ports or components can also be provided to allow one or more additional devices or components to be used with the data capture stations. Different features and further variations can also be implemented, if desired, and related systems and methods can be utilized as well.

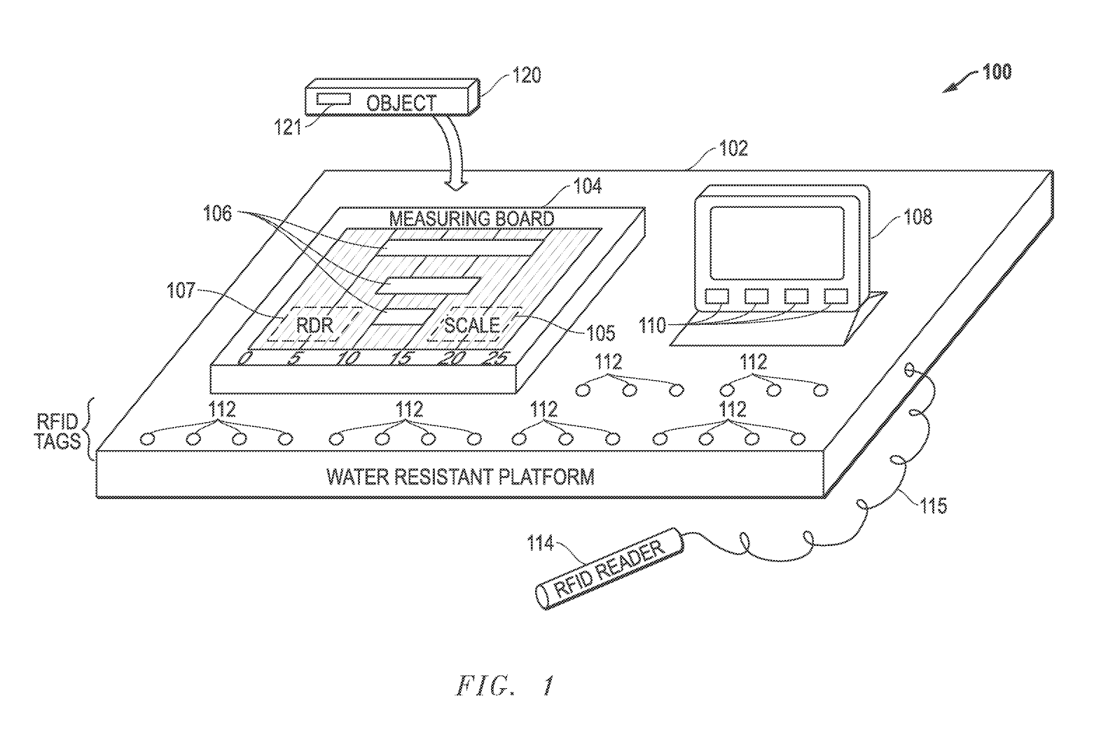

FIG. 1 is a perspective diagram of an example embodiment 100 for an integrated data capture system. A platform 102, such as a water resistant platform, provides structural support for measuring board 104 that includes an integrated scale 105 and an integrated reader (RDR) 107, for example, integrated as part of the platform 102 under the surface of the measuring board 104. The platform 102 can also support a display 108. The scale 105 automatically measures the weight of an object 120 placed on the measuring board 104. The reader (RDR) 107 is an RFID reader that is configured to automatically read the object identifier from an RFID tag 121 embedded within or otherwise attached to the object 120. As described herein, a series of RFID tags 112 are integrated with the platform 102, and these RFID tags 112 include unique identifiers that are associated with object data values through one or more configuration files to allow automated data entry for objects being processed using the capture station embodiment 100. For example, rather than require manual keypad data entry, different data values can be associated with the RFID tags 112 so that the selectively reading of an individual RFID tag 112 can be used to select a data value for a feature (e.g., length, color, health, etc.) of the object.

A movable RFID reader 114 is provided for the integrated capture station embodiment 100. The RFID reader 114 can be selectively positioned by an operator over each of the RFID tags 112 and then used to read the unique identifiers stored within each of the RFID tags 112. It is also noted that the RFID reader 114 can be attached to the platform 102, for example, using a cord 115. The RFID reader 114 could also be left unattached from the platform 102, if desired. As described further below, the RFID reader 114 can provide the unique identifiers read from the RFID tags 112 to a controller 202 for use in identifying data values to store for the object within a data storage system 204 using one or more configuration files. These communications can be wired communications, for example, through the cord 115, or can be wireless communications. Other variations could also be implemented.

The measuring board 104 can include one or more markings on its surface that provide size measurements. For the embodiment depicted, size markings are included for 0 centimeters (cm), 5 cm, 10 cm, 15 cm, 20 cm, and 25 cm, although different and/or additional size markings could also be used. In addition, preset size bars 106 can also be included within the markings to allow for quick measurements by an operator. For the embodiment depicted, preset size bars 106 are included for 5 cm, 10 cm, and 15 cm, although different and/or additional size markings could also be used.

The display 108 is used in part to display a weight value associated with the weight being measured by the scale 105. For example, a weight value in kilograms (kg) can be displayed through the display 108 for the weight measured by the scale 105, such as the weight of an object 120 that has been placed on the measuring board 104. The display 108 can also include one or more touch sensitive buttons 110, which can be used to clear the scale, accept the weight value being displayed, and/or for other purposes. The display 108 can also be used to display other information regarding the operation of the data capture station. For example, information concerning configuration files that are stored within the system can be displayed through the display 108, and an operator can be allowed to select a configuration file to load for a given capture session by toggling through and selecting the available configuration files using the touch sensitive buttons 110. The display 108 can also be used to display information concerning the data values that have been assigned to the RFID tags 112. Other variations could also be implemented.

To provide protection from environmental conditions, the RFID tags 112 can be sealed within the platform 102. For example, the platform 102 can be made using metal, wood, plastic, and/or some other desired material. A void can then be formed within the platform 102 for each of the RFID tags 112 to be embedded and sealed within the platform 102. For example, a drill, router, or other device or tool can be used to remove material from the surface of the platform 102 to form the voids. Further, the voids can also be formed by molding the voids into the platform 102 when it is manufactured. Other techniques could also be used, as desired, to form the voids for the RFID tags. An RFID tag can then be placed within each of the voids, and the voids can be sealed with a sealant such as an epoxy resin or other material that provides protection from exposure. This protective material can be selected such that it does not interfere with reading of the RFID tags 112 by the RFID reader 114.

As described herein, the RFID tags 112 are associated with one or more object data values using one or more configuration files 206A, 206B, 206C . . . that are stored within a data storage system 204. A plurality of configuration files can be provided, and each configuration file can identify a different set of data values that are associated with the unique identifiers. At the beginning of any data collection session, one of the configuration files can be selected for use during that data collection session. The data collected by reading the RFID tags 112 during the session will, therefore, be dependent upon this selected configuration file. If a new data collection session is desired, a new configuration file can be selected. Thus, the disclosed embodiments provide for a wide variety of object data values to be defined and automatically collected through the use of the RFID tags 112 and the configuration files without requiring manual keypad data entry during the data collection session.

During data collection, the object 120 is placed by an operator on the measuring board 104. The object reader (RDR) 107 automatically reads the RFID tag 121, if any, within the object 120. The scale 105 automatically measures the weight of the object. This weight value is displayed on the display 108. The operator can accept the displayed weight value, for example, by selecting one of the pressure sensitive buttons 110. The object identifier and the weight value can then be stored as object data values as further described below. Further, the object identifier can be used as a key within the database 208 to identify a data record for a particular object. If object identifiers from the object itself are not available, other keys can be generated or used to identify the data record for a particular object. The operator can also use the size markings on the measuring board 104 to determine a size for the object. Rather than manually enter this size, the operator uses the RFID reader 114 to read one of the RFID tags 112, which can be associated with different sizes, as further described below. As such, the size values for the object can be automatically collected without requiring manual data entry through a keyboard. The RFID tags 112 and the RFID reader 114 can be similarly used to collect additional data with respect to the object depending upon how object data values have been programmed and associated with the RFID tags 112.

As one example, the integrated capture station embodiment 100 can be used to collect data associated with fish, and a different configuration file can be used for different collection sessions. For instance, if a data capture session for a first day requires measuring the length of smolts (i.e., juvenile fish), which can range in length from 10 to 15 cm, in 1 cm intervals, six (6) of the RFID tags 112 can be used and assigned the data values for 11 cm, 12 cm, 13 cm, 14 cm and 15 cm, respectively, though a configuration file selected for the data capture session. During the data capture session, each fish is placed on the measuring board 104 into which the scale 105 and RFID reader 107 are integrated. The unique object identifier number for the fish, if present, is captured automatically using the RFID reader 107. The weight is captured automatically using the scale 105. The operator can then use the RFID reader 114, which can be a pen-type wand, to selectively read the RFID tag corresponding to the length of the specimen. For example, if the fish is 12 cm in length, the RFID tag associated with the 12 cm data value is read using the RFID reader 114. This data value can then be automatically stored as part of the object data. With respect to this data capture for fish, other object data values can be assigned to the RFID tags 112 in addition to and/or instead of length. For example, meanings or data values that can be assigned to the RFID tags 112 include but are not limited to: sex (e.g., male/female), deformities, color (e.g., scale of 1 to 14), number of parasites present, and/or other desired data. As such, the integrated RFID tags 112 along with the configuration files allow for great flexibility in automatic capture of data during a data capture session.

Advantageously, the disclosed embodiments allow for automatic data collection using the integrated RFID tags 112, scale 105, and object reader 107 without requiring manual data keypad entry through a keyboard or other keypad. This automated data collection for objects, such as fish or other animals, helps to eliminate data entry errors and allows for the integrated capture station embodiments to be water resistant or waterproof so that components are protected from corrosion and degradation from environmental conditions.

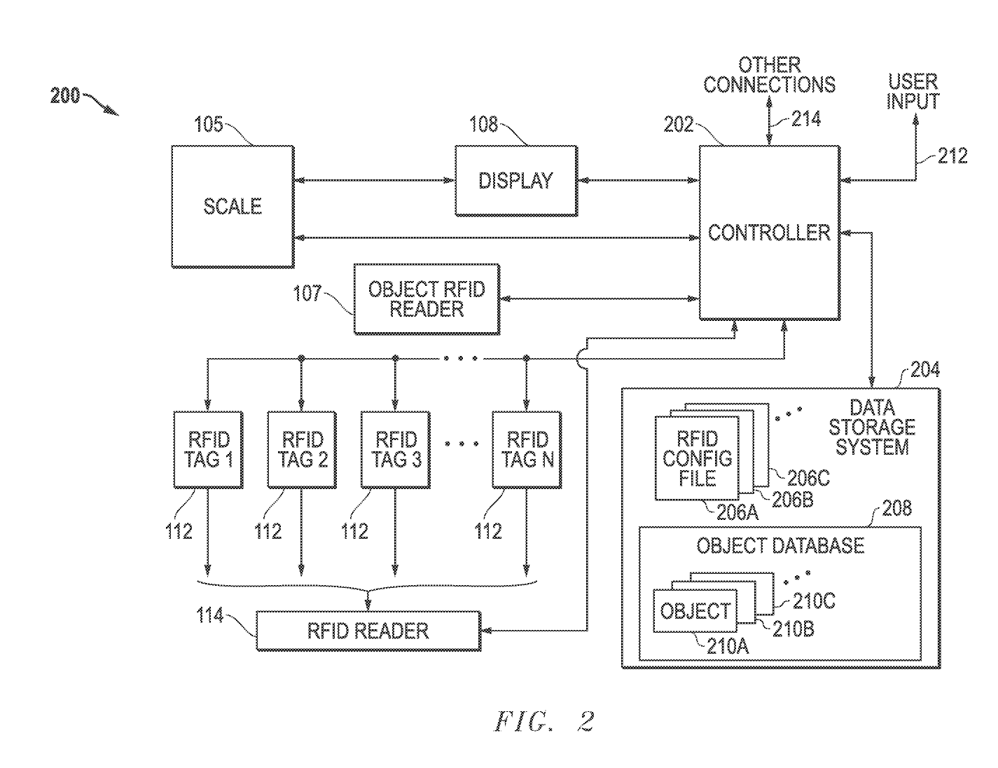

FIG. 2 is a block diagram of an example embodiment 200 for components of the integrated capture station 100. A controller 202 communicates with the scale 105, the display 108, the object RFID reader 107, and the RFID reader 114 to obtain object data values collected for the object 120. These object data values for a particular object are stored within one of the object records 210A, 210B, 210C . . . within an object databased 208 within the data storage system 204. The unique identifiers stored within each of the N different RFID tags 112 can also be selectively read by the RFID reader 114 to select additional object data values that are also stored within the object record for the object being processed. The unique identifiers are associated with object data values through the RFID configuration files 206A, 206B, 206C . . . stored within the data storage system 204. For example, each of the RFID configuration files 206A, 206B, 206C . . . can include one or more data tables that associate one or more object data values to each of the unique identifiers. As described herein, the RFID configuration files 206A, 206B, 206C . . . allow for wide flexibility in assigning meaning and data values to each of the RFID tags 112.

The RFID configuration file to be used for any particular data capture session can be selected, for example, through user input 212. The user input 212 can be provided, for example, through one or more touch sensitive buttons 110 that are integrated as part of the display 108. In addition, one or more user input devices can be connected to the system through other connections 214. These other connections 214 can be, for example, one or more wired or wireless communication ports or components that allow connection of additional devices or computing systems to facilitate the management and control of the data capture system. As one further example, a laptop computer could be connected to the data capture system through a wired communication port or through a wireless connection, and this laptop could then be used to download or define the configuration files 206A, 206B, 206C . . . stored within the data storage system 204. Further, such a laptop computer could be used to retrieve the data values stored for each object, such as within object records 210A, 210B, 210C . . . , for later analysis by the laptop computer or other computer systems. Handheld computing devices, such as mobile handsets or tablet computing systems, could also be used. Other variations could also be implemented while still taking advantage of the integrated data capture embodiments described herein.

It is also noted that the controller 202 can be implemented, for example, using one or more processing devices such as processors, microcontrollers, microprocessors, central processing units, configurable logic devices, field programmable gate arrays, complex programmable logic devices, and/or other processing devices that are programmed to control and/or implement the functionality described herein. It is further noted that the data storage system 204 can be implemented, for example, as one or more data storage mediums such as random access memories, FLASH memories, non-volatile memories, and/or other memory devices. Other variations and implementations can also be implemented as desired.

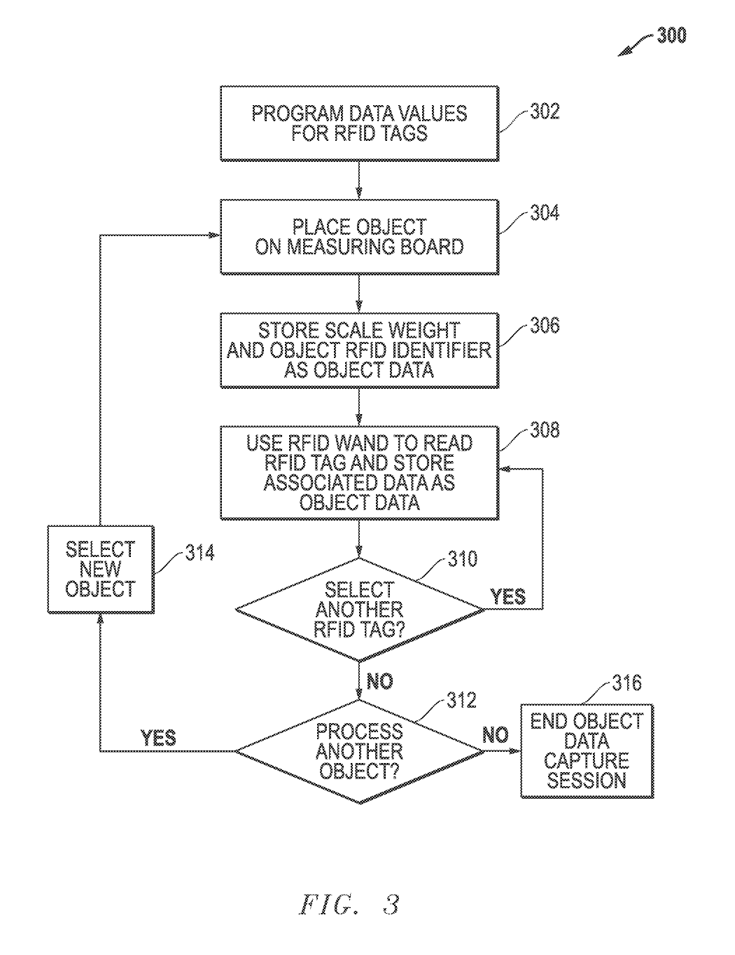

FIG. 3 is a process flow diagram of an embodiment 300 for data capture for animals, such as fish, or other objects. In block 302, object data values for the RFID tags 112 are defined and/or programmed, for example, by selecting one of the RFID configuration files 206A, 206B, 206C . . . stored within the data storage system 204. In block 304, an object is placed on the measuring board 104. In block 306, the weight measured with the scale 105 and the unique object identifier, if any, read by the object RFID reader 107 are both stored as object data within the object record for the object. In block 308, the RFID reader or wand 114 is used to selectively read one of the RFID tags 112 and to automatically store the one or more associated data values as object data within the object record for the object. In block 310, a determination is made whether another RFID tag is to be selected. If “YES,” then flow passes back to block 308. If “NO,” then flow passes to block 312 where a determination is made whether another object is to be processed. If “YES,” then flow passes to block 314 where a new object is selected for data capture, and flow then proceeds back to block 304. If “NO,” then flow passes to block 316 where the object data capture session is ended. It is noted that additional and/or different process flow blocks could also be used as desired while still taking advantage of the integrated data capture embodiments described herein.

It is further noted that the functional components described herein can be implemented using hardware, software, or a combination of hardware and software, as desired. In addition, one or more processing devices running software and/or firmware can also be used, as desired, to implement the disclosed embodiments. It is further understood that one or more of the operations, tasks, functions, or methodologies described herein may be implemented, for example, as software or firmware and/or other program instructions that are embodied in one or more non-transitory tangible computer readable mediums (e.g., memory) and that are executed by one or more controllers, microcontrollers, microprocessors, hardware accelerators, processors, processing circuitry and/or other processing devices to perform the operations and functions described herein.

Further modifications and alternative embodiments of this invention will be apparent to those skilled in the art in view of this description. It will be recognized, therefore, that the present invention is not limited by these example arrangements. Accordingly, this description is to be construed as illustrative only and is for the purpose of teaching those skilled in the art the manner of carrying out the invention. It is to be understood that the forms of the invention herein shown and described are to be taken as the presently preferred embodiments. Various changes may be made in the implementations and architectures. For example, equivalent elements may be substituted for those illustrated and described herein, and certain features of the invention may be utilized independently of the use of other features, all as would be apparent to one skilled in the art after having the benefit of this description of the invention.

1. A method for automated object data capture, comprising:
placing an object on a platform;
automatically measuring a weight for the object with a scale integrated with the platform to generate a weight value;
selectively reading one or more radio frequency identification (RFID) tags integrated with the platform, each RFID tag having a unique identifier stored within the RFID tag;
automatically identifying one or more object data values including an object length value for the object using one or more configuration files that associate one or more object data values with each of the unique identifiers, the one or more object data values comprising different object length values; and
automatically storing the weight value and the one or more object data values including at least one object length value for the object within a data storage system; and
repeating the placing, automatically measuring, selectively reading, automatically identifying, and automatically storing for a plurality of objects.

2. The method of claim 1, wherein the RFID tags are sealed within the platform and the platform is water resistant.

3. The method of claim 1, further comprising automatically reading an object identifier from an RFID tag associated with the object and including the object identifier within the object data values stored for the object in the data storage system.

4. The method of claim 1, wherein the placing comprises placing the object on a length measurement board integrated with the platform, and wherein the scale is integrated with the length measurement board.

5. The method of claim 4, further comprising automatically reading an object identifier associated with the object using an RFID reader integrated with the length measurement board.

6. (canceled)

7. The method of claim 1, wherein the one or more configuration files comprise a plurality of configuration files having different sets of object data values including different object length values.

8. The method of claim 1, further comprising selecting one of a plurality of configuration files for the automatically identifying.

9. The method of claim 1, wherein the selectively reading is performed by separately positioning an RFID reader to read each one the one or more RFID tags.

10. The method of claim 1, wherein the plurality of objects comprises fish.

11. A system for automated object data capture, comprising:
a platform;
a scale integrated with the platform and configured to automatically measure a weight for an object placed on the scale to generate a weight value;
a plurality of radio frequency identification (RFID) tags integrated with the platform, each RFID tag having a unique identifier stored within the RFID tag;
an RFID reader configured to read the unique identifiers from the RFID tags;
a data storage system;
one or more configuration files stored within the data storage system, each configuration file associating one or more object data values with each of the unique identifiers for the RFID tags, the one or more object data values for a plurality of the unique identifiers comprising different object length values; and
a controller configured to automatically receive the weight value and the unique identifiers read by the RFID reader, to automatically identify one or more object data values including object length values associated with each of the unique identifiers read by the RFID reader using the one or more configuration files, and to automatically store within the data storage system the weight value and the one or more object data values for the object.

12. The system of claim 11, further comprising a display integrated with the platform and configured to display the weight value.

13. The system of claim 11, wherein the RFID tags are sealed within the platform and the platform is water resistant.

14. The system of claim 11, further comprising an RFID reader integrated with the platform and configured to automatically read an object identifier from an RFID tag associated with the object, and wherein the controller is further configured to store the object identifier within the object data values stored for the object in the data storage system.

15. The system of claim 11, further comprising a length measurement board integrated with the platform, and wherein the scale is integrated with the length measurement board.

16. The system of claim 15, further comprising an RFID reader integrated with the length measurement board and configured to automatically read an object identifier from an RFID tag associated with the object.

17. The system of claim 11, wherein the one or more configuration files comprise a plurality of configuration files having different sets of object data values including different object length values.

18. The system of claim 11, wherein a plurality of configuration files are stored in the data storage system, and wherein the controller is further configured to allow user selection to determine which configuration file is used to automatically identify one or more object data values associated with each of the unique identifiers read by the RFID reader.

19. The system of claim 11, further comprising an RFID reader configured to be selectively positioned with respect to the RFID tags and to read unique identifiers from the RFID tags.

20. The system of claim 11, wherein the plurality of objects comprise fish.
